(19) United States
(12) Patent Application Publication
(10) Pub. No.: US 2020/0015463 A1
(43) Pub. Date: Jan. 16, 2020

(54) Trap

(71) Applicant: BLT Holdings Group, LLC, Tampa, FL (US)

(72) Inventors: Robert Benjamin Norburn, Lancashire (GB); Steven Philip Simpkin, Lancashire (GB)

(21) Appl. No.: 16/035,782

(22) Filed: Jul. 16, 2018

(51) Int. Cl. A01K 69/08

(52) U.S. Cl. CPC A01K 69/08; A01M 23/18

(57) ABSTRACT

A trap for catching marine creatures such as fish and crustaceans that is approximately in the shape of a triangular prism.

### BACKGROUND INFORMATION

### Field of the Invention

The invention relates to traps, and in particular traps that are designed for use in a body of water to catch crustaceans, for example, lobsters, crabs, langoustine and/or thenus.

### Discussion of Prior Art

Crustacean traps, in particular lobster traps, are widely known and have been used for years. Historically, the traps were made of wood and were cuboid in shape. In modern fishing, the shape largely remains the same but the traps are typically made from a carbon steel mesh coated in polyvinyl chloride to reduce corrosion or, alternatively, the mesh may be made from ferrous, non-ferrous or plastic material.

There are generally one or more openings in the sides of the traps, commonly filled with a type of netting referred to as side heads or entrance heads, which allow lobsters to enter the trap and are constructed in such a way to diminish the likelihood of the lobsters exiting the traps once they enter. Parlor heads or funnel nets are commonly added to the inside of the trap to further prevent the lobsters from escaping. There is typically some form of door that a user may open in order to remove the catch and/or replenish a bait supply. And, typically large amounts of ballast are added so that the traps set in the functional manner, i.e., so that the heads are positioned in the proper manner, and so that the traps hold their position on the ocean floor and are not moved by the ocean currents and conditions.

Although this form of trap dominates the industry it has a number of disadvantages and/or inefficiencies. The crux of these disadvantages and/or inefficiencies is that much of the space at the top of the trap is unused. This means that constructing a trap requires more material than is needed for effective trapping. It also means that the traps weigh more than is necessary because of the excess material and because of the ballast that is required to set the trap in the proper manner. Finally, this means that the traps take up more space than necessary, both on the boat and when on land, making transportation and storage more cumbersome.

What is needed, therefore, is a trap that functions at least as well as the modern trap but is constructed in an efficient manner that saves on space, weight and materials.

### BRIEF SUMMARY OF THE INVENTION

The invention is a trap for catching crustaceans such as lobsters, crabs, langoustine and/or thenus and related species that is approximately in the shape of a triangular prism. The shape of the trap provides the interior space needed to catch and hold the crustaceans while also requiring significantly less material to construct, thereby reducing the cost to manufacture a trap, reducing the weight of the trap and reducing the space required to store and transport the trap.

Lobsters in particular do not need or use the top corners of a traditional trap, only the space on the bottom, or floor, of the trap which is provided in the claimed design. Unlike the cuboid traps, the claimed invention may function, i.e. trap crustaceans, regardless of which side lands on the ocean floor. The approximately triangular prism shape also causes the trap to self-right as it lands on the ocean floor, meaning that it always lands in a functional orientation so long as the ocean floor is relatively flat. Additionally, the triangular shape also results in a trap that has much less drag in the water and therefore holds its position better than the conventional square or rectangular shaped trap. As a result, the trap does not need additional weight or ballast to cause it to land in a desired manner and hold its position on the ocean floor.

As a result of the claimed design, the inventive trap weighs considerably less than a conventional trap. The result being, a boat carrying the inventive traps has less work to do, representing a savings in fuel for the boat, and perhaps more importantly keeping the center of gravity of the boat low and thereby making the boat safer and more stable. Lighter traps are also easier for fishermen to work with as well as safer; for example, if a fisherman is snagged in a line as the trap is setting it is much easier to free oneself from a 30 pound trap as opposed to a 100 pound fully ballasted trap.

The claimed design also takes approximately forty percent less deck space when compared to conventional traps of a similar size in height, length, and width, which means that a fisherman may put the same number of traps on a boat without stacking them as high, thereby reducing the risk of the boat capsizing. Additionally, when stacked the traps lock into each other as the second level fits “V” down into the first row of traps that is sitting “V” up which means that the claimed trap is much less likely to move across the deck, again adding stability.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a perspective view of the trap according to the invention showing the top, side and ends of the trap being made of a wire mesh.

FIG. 2 is a perspective view of the trap having sides made of a solid material and without showing ends on the trap.

FIG. 3 is a top plan view of the trap.

FIG. 4 is a side plan view of the trap.

FIG. 5 is an end plan view of the trap.

FIG. 6 is an end plan view of an embodiment of the trap where flat sections are used to connect the side walls.

FIG. 7 is a perspective end view of the trap having flat sections optionally connecting the sidewalls or the sidewalls having gaps.

FIG. 8 is a perspective view of a trap having solid sidewalls that have gaps.

FIG. 9 is an end plan view of the trap that allows for a gap between the sidewalls.

FIG. 10 is a front plan view of an end gate, which may be attached to the trap in a manner that is fixed, pivoting, or as a flexing hinge.

FIG. 11A is a side plan view of an end gate.

FIG. 11B is a front plan view of an end gate.

FIG. 11C is a top plan view of an end gate.

FIG. 12 is a front plan view of an end that is slidably attached to the sidewalls.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

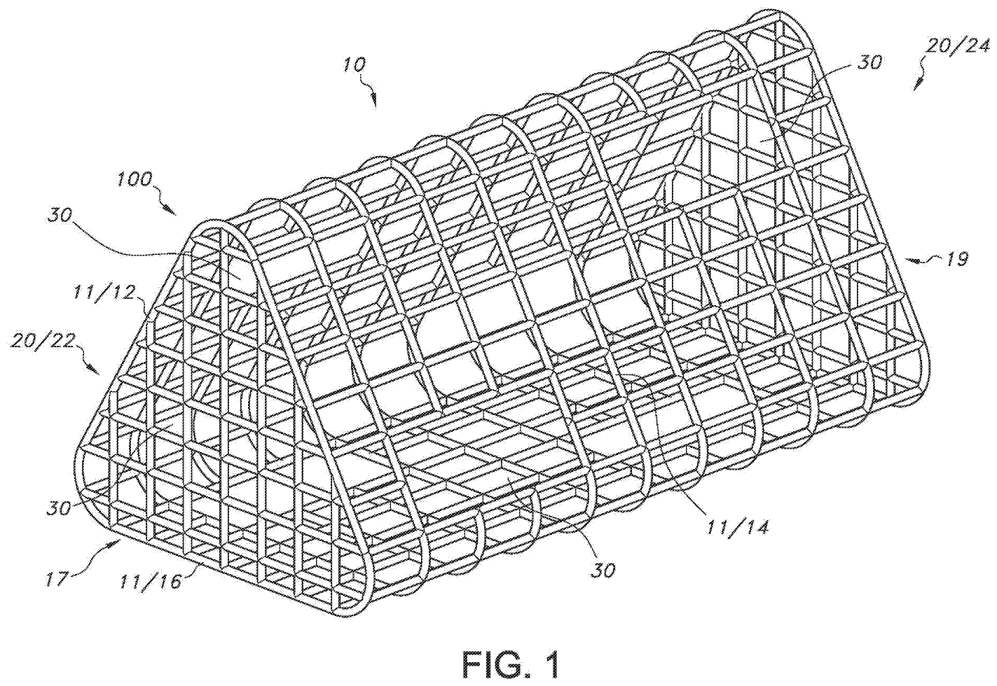

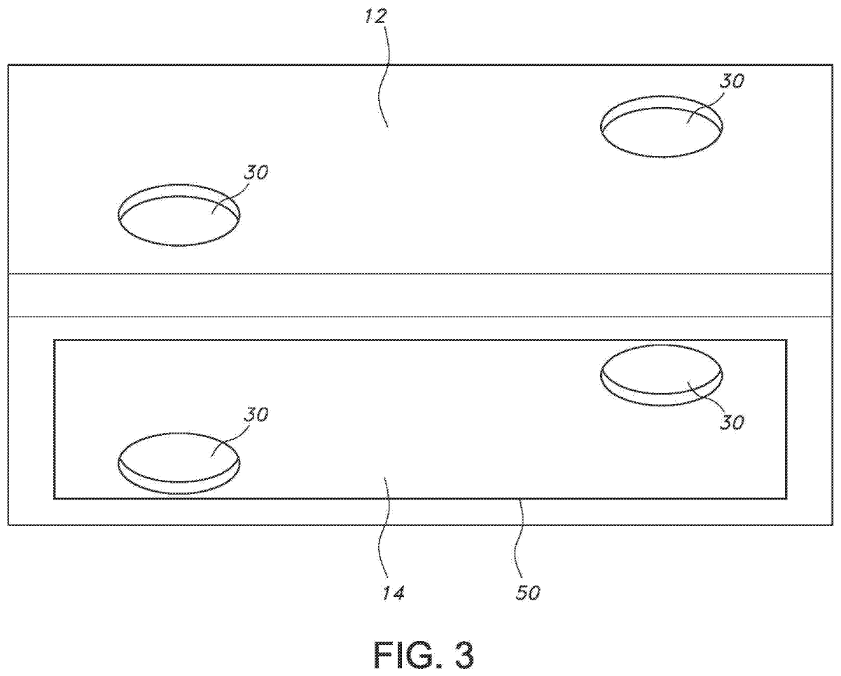

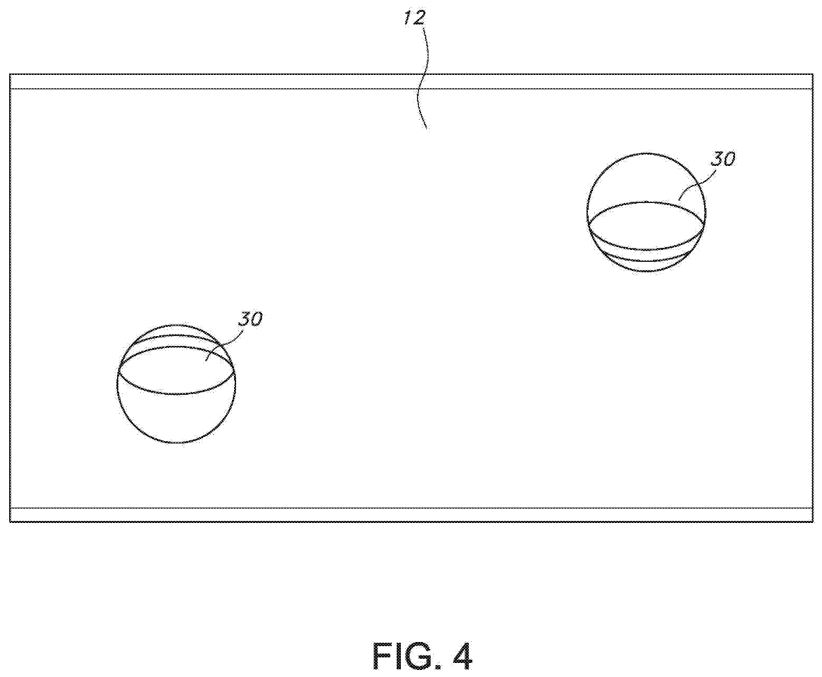

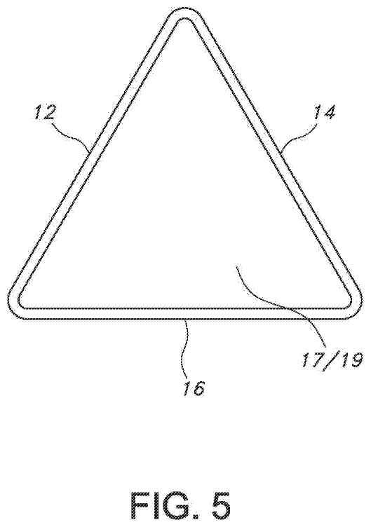

FIGS. 1-5 illustrate a trap 100 according to the invention for catching crustaceans such as lobsters, crabs, langoustine and/or thenus and related species. The trap includes a trap frame 10 and at least two trap ends 20, the trap frame 10 and the at least two trap ends 20 being connected in a manner that creates an enclosed three-dimensional shape that is sufficient in size to hold the creatures that it is intended to catch. The trap ends 20 may be referred to herein simply as “ends” for the sake of brevity.

More specifically, the trap 100 shown in the first embodiment is approximately in the shape of a triangular prism. The trap frame 10 includes three sidewalls 11 that include a first sidewall 12, a second sidewall 14, and a third sidewall 16, each sidewall 11 having four edges and approximately being in the shape of a parallelogram. The sidewalls 11 are connected to one another in a manner that creates an approximately triangular prism shaped object with a first frame end 17 and a second frame end 19. Both frame ends 17, 19 are open ends on the trap frame 10. The at least two trap ends 20 include a first trap end 22 and a second trap end 24, both trap ends 22, 24, being approximately triangular in shape. To create an enclosed trap 100, the trap ends 22, 24, are attached to the frame ends 17, 19.

In the embodiment shown in FIGS. 1-5 the frame 10 is made from a single piece of bendable material, such as a wire, bendable metal, or moldable plastic. There is a slight radius R where the frame 10 is bent into its “V” shape. The radius may or may not be present depending on the type of material chosen and how pliable that material is. Typically, when present, this radius measures one to three inches.

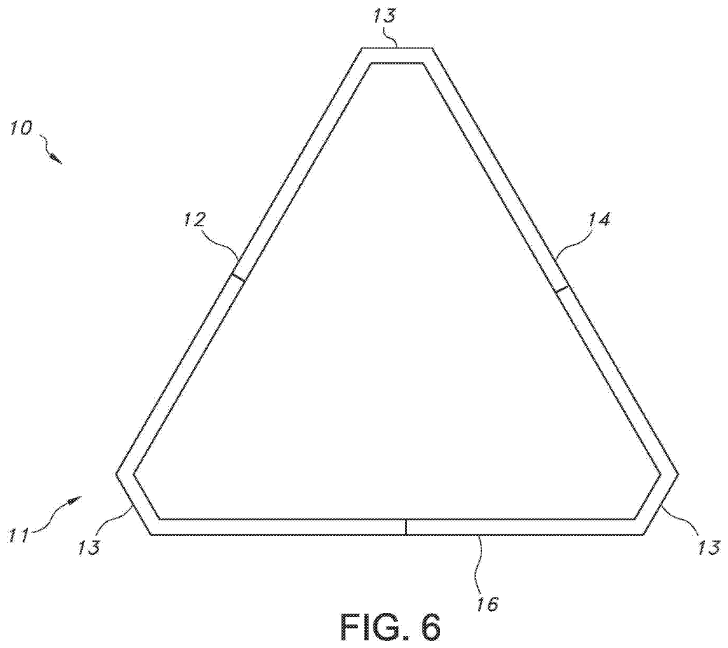

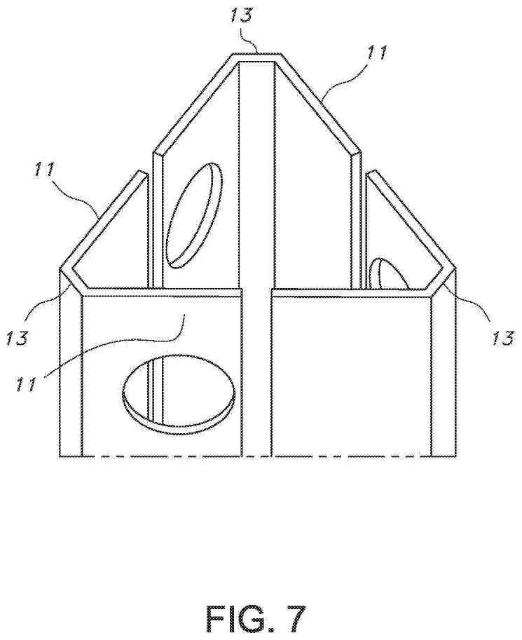

Some materials, in particular certain plastics and metals, are difficult to bend at a suitable radius, and so a flat section 13 may be needed at the bends in the approximately triangular shape, as shown in FIGS. 6 and 7. While this embodiment is still approximately triangular in shape and has all of the advantages of the other embodiments, the frame 10 may be considered a six-sided structure. This flat section 13 is constructed using conventional means during the bending or molding process.

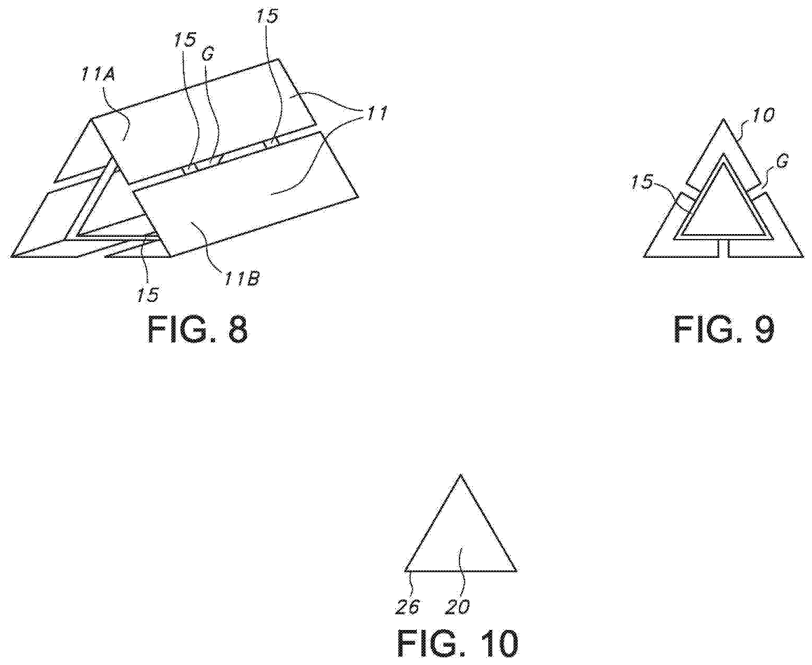

Alternatively, the sidewalls 11 may be separate panels that are connected by conventional means such as welding or using fasteners such as hog rings. When the sidewalls 11 are separate panels it is likely that there is little to no radius at the points of the sidewalls, as shown in FIGS. 8-10 and 12. The sidewalls 11 may also be constructed in manner that allows small gaps G as shown in FIGS. 8 and 9. FIG. 8 in particular illustrates an embodiment where a sidewall 11 includes two panels, 11A and 11B, which are connected by a bridge 15 that leaves a gap G. The gaps G may be advantageous to allow for the drainage of water and/or to allow small sea creatures to exit the trap 100. The bridge 15 may be any suitable connector, such as a piece of wire or metal that is affixed to both panels using conventional means such as welding or conventional fasteners such as hog rings.

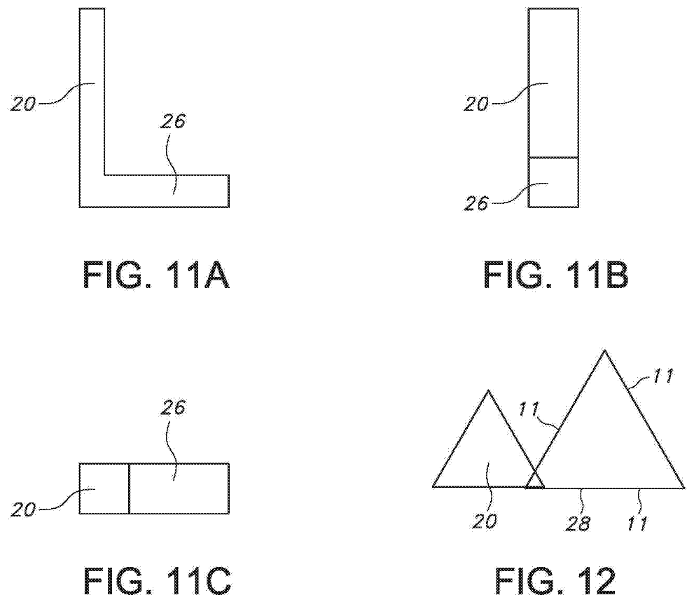

The triangular ends 20 are approximately equilateral triangles. The ends 20 may be affixed to the trap frame 10 such that they act as end walls, or the ends 20 may be attached by one or more conventional hinges 26 such that they act as gates and allow a user and/or crustaceans access to the inside of the trap 100. More specifically, the ends 20 may be hingedly attached or constructed to flex internally, such as with the end gates shown in FIGS. 10 and 11A-11C, or to slide away on one or more conventional rails 28, shown in FIG. 12, thereby allowing the catch to be decanted. As such, the ends 20 do not make a substantial contribution to the structural integrity of the trap 100, on the contrary, it is generally the trap frame 10 that supports the shape of the trap 100.

The trap frame 10 and ends 20 may be produced from ferrous, non-ferrous or plastic, mesh, such as is shown in FIG. 1, where the ferrous/carbon steel wire is likely to be coated in a polyvinyl carbonate. In this embodiment, the trap frame 10 and ends 20 are connected to one another using conventional means such as, for example, cable ties, hog rings, compression fittings or the like, or welded together. There are number of conventional wires that may be used having different gauges and/or diameters, with 8 gauge through to 18 gauge wires being most common and applicable.

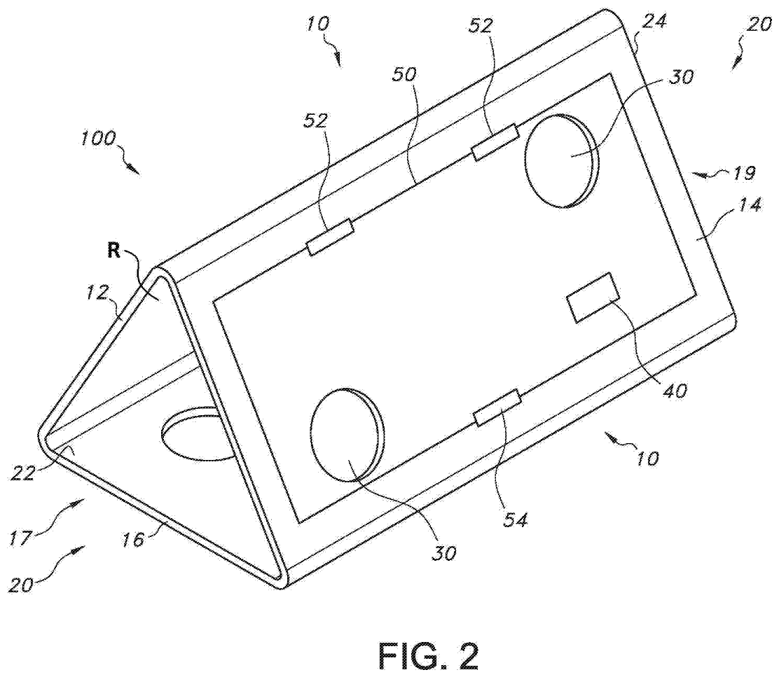

The trap frame 10 and ends 20 may also be a largely solid material, as shown in FIGS. 2-4, preferably of a specific gravity greater than 1.0 so that ballast might not be required to sink the trap, and having one or more openings 30 to allow marine creatures to enter the trap. In this embodiment the trap frame 10 and ends 20 are also connected to one another using conventional means, such as welding or other mechanical means such as those used with the wire mesh embodiment.

The trap frame 10 and ends 20 may also be a combination of wire mesh and solid materials. For example, one sidewall 11 may be solid to act as a floor of the trap with the other two sidewalls 11 being wire mesh and the ends 20 being wire mesh. Furthermore, the sidewalls 11 and ends 20 may also be bent from a single panel of mesh or formed from a plastic sheet such that there are no separate sections to attach. The trap frame 10 and ends 20 may be connected to one another in a manner that leaves little to no space between the sidewalls 11 and ends 20, or they may be connected to so as to allow a gap between the sidewalls 11 and ends 20 as shown in FIG. 8.

The size of the trap frame 10 and ends 20 may vary depending on the targeted species and the location of the fishing grounds, but in general the sidewalls 11 are likely to be approximately 20 to 24 inches in height and 30 to 48 inches in length with the ends 20 sized to fit on the ends of the connected sidewalls 11.

As previously mentioned, the openings 30, commonly referred to as “heads”, are placed in one or more of the sidewalls 11, or the ends 20, to allow the marine creatures to enter the trap 100. Vents 40, shown in FIG. 2, may be included if desired or required by legislation to allow juveniles of the targeted species or other smaller marine creatures to exit the trap 100. A door 50 may be included on at least one of the sidewalls 11 or ends 20 to allow a user to open the trap 100 to collect the catch and/or replenish the bait. The door may be attached using conational means such as hinges 52 or hog rings and likely has a latch 54 to secure it in a closed position when fishing.

Heads 30 of a conventional construction and vents 40 may also be provided in each of, or anyone of, the three sidewalls 11 or the ends 20. Providing heads 30 in each of the sidewalls 11, as shown in FIG. 1, allows the trap to function effectively regardless of which sidewall 11 lands on the ocean floor, and as such the traps 100 do not require the traditional ballast that is conventionally used to deploy the trap in a functional orientation as it is likely to fish in any position in which it lands.

This approximately triangular shape of the trap 100 reduces the amount of deck space needed to transport a number of traps by approximately forty percent when compared to conventional traps of similar width, length, and height dimensions. The shape of the trap also result is significantly less drag, thereby reducing or eliminating the need to add ballast in order to help the trap hold its position when it is submerged. The reduced trap size and lack of ballast may reduce the weight of the trap to about twenty percent of a conventional trap, enabling safer and more cost effective fishing.

It is understood that the embodiments described herein are merely illustrative of the present invention. Variations in the construction of the trap may be contemplated by one skilled in the art without limiting the intended scope of the invention herein disclosed and as defined by the following claims.

What is claimed is:

1. A trap for catching crustaceans, the trap comprising:
a frame that includes a first sidewall, a second sidewall and a third sidewall, each sidewall having four edges, the first sidewall being attached to at least a portion of the second sidewall and to at least a portion of the third sidewall and third sidewall being attached to at least a portion of the second sidewall so as to form a three-dimensional shape having three sides and a first frame end and a second frame;
a first trap end connected to at least a portion of the first frame end and a second trap end connected to at least a portion of the second frame end.

2. The trap of claim 1, wherein the frame is constructed from a single piece of material.

3. The trap of claim 1, where each of the first sidewall, second sidewall, and the third sidewall are separate panels that are attached to one another using fastening means.

4. The trap of claim 1 wherein each of the first sidewall, the second sidewall and the third sidewall are in the shape of a parallelogram.

5. The trap of claim 4 wherein each of the first trap end and the second trap end are in the shape of a triangle.

6. The trap of claim 5 wherein each of the first trap end and the second trap end are in the approximate shape of an equilateral triangle.

7. The trap of claim 6 wherein the three-dimensional shape is a triangular prism.

8. The trap of claim 7, further comprising at least one opening in at least one of the first sidewall, second side wall, third sidewall, first trap end, or second trap end, and wherein the crustaceans are able to enter the trap through the at least one opening.

9. The trap of claim 8, further comprising a door that allows a user to remove the crustaceans that are caught in the trap.

10. The trap of claim 9 wherein the door is the first trap end, the first trap end being hingedly attached to either of the first sidewall, the second sidewall or the third sidewall.

11. The trap of claim 9 wherein the door is the first trap end, the first trap end being slidably coupled to either of the first sidewall, the second sidewall or the third sidewall.

12. The trap of claim 7 wherein the first sidewall, second sidewall, third sidewall and first trap end and second trap end are each made from a wire mesh material.

13. The trap of claim 7 wherein the first sidewall, second sidewall, third sidewall and first trap end and second trap end are each made from a solid material.

14. The trap of claim 7 wherein the first sidewall and second sidewall are made from a wire mesh material and the third sidewall is made from a solid material.

15. The trap of claim 7 wherein the first sidewall is made from a mesh material and the second sidewall and third sidewall are each made from a solid material.

16. The trap of claim 7 wherein the first end and the second end are each attached to the first sidewall second sidewall and third sidewall in a manner that leaves a gap between sides of the trap ends and the sidewalls.

17. The trap of claim 7 wherein each of the plurality of sidewalls includes two panels that are connected to one another in a manner that creates a gap between the two panels.

18. A trap frame for a trap that catches crustaceans, the trap frame comprising:
a first sidewall, a second sidewall and a third sidewall, each sidewall having four edges, the first sidewall being attached to at least a portion of the second sidewall and to at least a portion of the third sidewall and third sidewall being attached to at least a portion of the second sidewall so as to form a three-dimensional shape having three closed sides and two open ends.

19. The trap frame of claim 18, wherein each of the first sidewall, the second sidewall and the third sidewall are in the shape of a parallelogram.

20. The trap frame of claim 19, wherein the three-dimensional shape is approximately a triangular prism.
